(19) United States
(12) Patent Application Publication
(10) Pub. No.: US 2005/0018937 A1
(43) Pub. Date: Jan. 27, 2005

(54) Method of producing a holding collar with progressive transition

(75) Inventor: Pascal Lagorgette, Sevrier (FR)

Correspondence Address: ARENT FOX KINTNER PLOTKIN & KAHN, 1050 CONNECTICUT AVENUE, N.W., SUITE 400, WASHINGTON, DC, 20036, US

(73) Assignee: S.N.R. ROULEMENTS

(21) Appl. No.: 10/892,130

(22) Filed: Jul. 16, 2004

(30) Foreign Application Priority Data
Jul. 24, 2003 (FR) 03 50366

(51) Int. Cl. F16C 35/00; B23P 11/00

(52) U.S. Cl. 384/428; 29/898.07; 29/510

(57) ABSTRACT

A method of producing an essentially radial annular collar on the hollow annular end part (15) of a component (7), said method comprising a deformation step so as to obtain a collar preform (23) having a radial part (23b) and a step of spreading said preform (23) so as to obtain, by pressing, the final forming of the collar;

in which, during the deformation, an intermediate portion (23e) of the free lateral surface of the radial part (23b) is inclined by a non-zero angle β with respect to the perpendicular to the axis (5) and, during the spreading, at least an end area of said intermediate portion (23e) is inclined by an angle δ with respect to the perpendicular to the axis (5), the angle δ being strictly greater than the angle β.

The invention also concerns a method of holding a bearing (1) on a shaft (7), and an assembly comprising a bearing (1) and a shaft (7).

The invention concerns a method of producing an essentially radial annular collar on the hollow annular end part of a component, a method of holding a bearing on the outer surface of a shaft, and an assembly comprising a bearing and a shaft.

There is known from the document FR 2 827 202 the production in two steps of an essentially radial annular collar on the hollow annular end part of a component. During a first deformation step, a preform having a radial part whose free surface is essentially flat and perpendicular to the axis of the component is obtained. A portion of this radial part is next spread so as to have an inclined free surface.

This two-step method has many advantages. It makes it possible in particular to significantly reduce on the one hand the forces applied to the bearing and on the other hand the forces on the forming tools. Therefore, premature deterioration of the bearing and especially of the tools is avoided.

The essentially radial annular collar can be used to hold a bearing on a shaft by applying sufficient holding tension between the bearing and the outer surface of the shaft. The collar is therefore dimensioned to withstand the large operating stresses.

But the application of the method, in particular to collar production on small-diameter shafts, can lead to large tensile stresses at the connection between the respectively flat and inclined portions of the collar.

The invention aims to improve the collar production method described in the document FR 2 827 202. To do this, the invention proposes a method of producing a collar in two steps in which the first step makes it possible to obtain a preform having a radial part whose free surface has an inclined intermediate portion, spreading next being applied to all or part of this intermediate portion in order to obtain the final form of the collar.

In this way, the stresses in the material are reduced by producing a progressive transition between the portion which is essentially flat and perpendicular to the axis of the component and the inclined portion of the collar, which is beneficial for the performance of the collar over time.

To that end, and according to a first aspect, the invention proposes a method of producing an essentially radial annular collar on the hollow annular end part of a component, said method comprising the steps making provision to:
radially deform the end part using a first tool, the axis of the tool and the axis of the end part forming a non-zero angle α between them, the tool and the end part being driven relatively with respect to each other on the one hand with a rotational motion about the axis of the end part and on the other hand with a linear motion along the axis of the end part, so as to obtain a collar preform having a radial part;
spread said preform using a second tool, said tool and said preform being driven with respect to each other with a linear motion along the axis of the preform so as to obtain, by pressing, the final forming of the collar;
   in which, during the deformation, an intermediate portion of the free lateral surface of the radial part is inclined by a non-zero angle β with respect to the perpendicular to the axis of the preform and in which, during the spreading, at least an end area of said intermediate portion is inclined by an angle δ with respect to the perpendicular to the axis of the preform, the angle δ being strictly greater than the angle β.

According to a second aspect, the invention proposes a method of holding a bearing on the outer surface of a shaft, said bearing comprising at least an inner race provided with an annular bore, an outer race and rolling bodies disposed between said races, said shaft having an external diameter substantially equal to the diameter of the bore and at least one hollow annular axial projection, said method comprising the steps making provision to:
coaxially dispose the shaft in the bore of the inner race so that at least an end part of the projection is disposed outside the bore;
produce on the projection, by implementation of the method described above, a collar extending radially outwards while abutting on at least part of the lateral face of the inner race, said collar forming a means of holding the inner race of the bearing.

According to a third aspect, the invention proposes an assembly comprising a bearing and a shaft, said bearing being held or immobilised on said shaft by implementation of the holding method described above, said collar comprising an axial part and an intermediate part which connects these two parts, the radial part having a free annular lateral reinforce and a free transverse and surface substantially parallel to the axis, the free annular lateral surface having a position substantially flat and perpendicular to the axis, an intermediate position inclined by an angle β with respect to the perpendicular to the axis and an end area inclined by an angle δ with respect to the perpendicular of the axis.

Other objects and advantages of the invention will emerge in the course of the following description, given with reference to the accompanying drawings, in which:

FIG. 1 depicts, in longitudinal section and schematically, an assembly comprising a bearing fitted on the outer surface of a wheel hub, before production of the collar forming a means of holding said bearing;

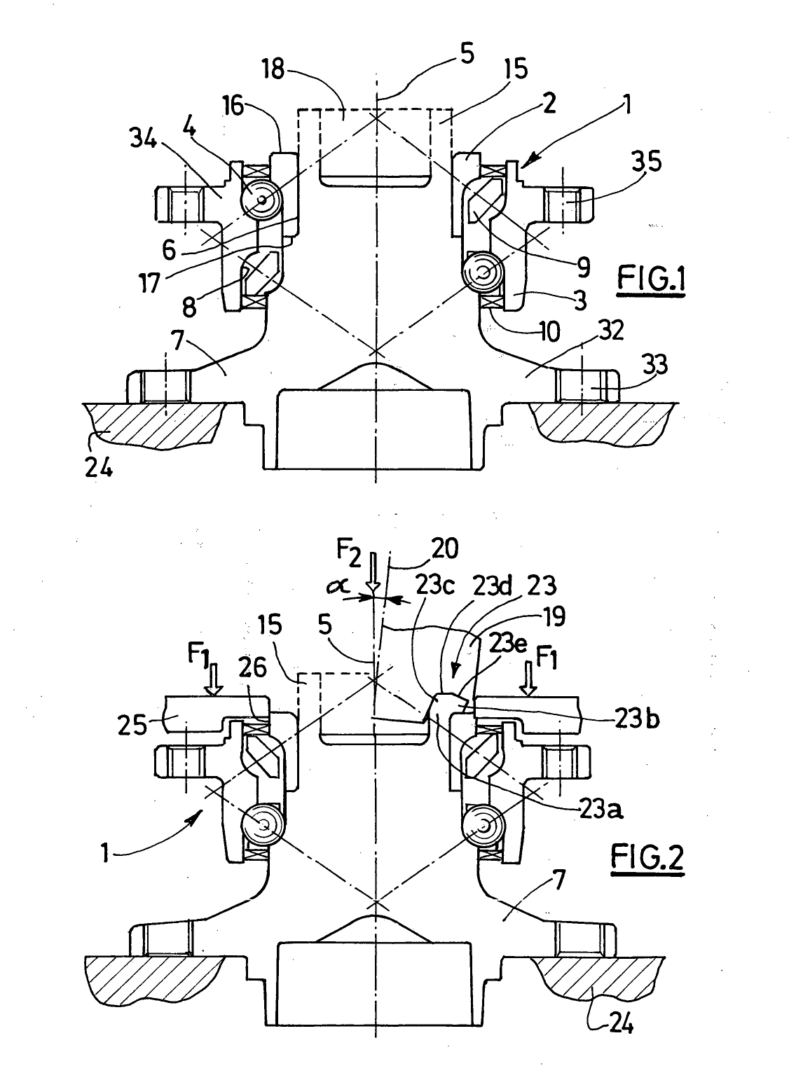

FIG. 2 depicts, in longitudinal section and schematically, the step of deforming the end part of the hub of the assembly of FIG. 1, with a view to forming a holding collar preform;

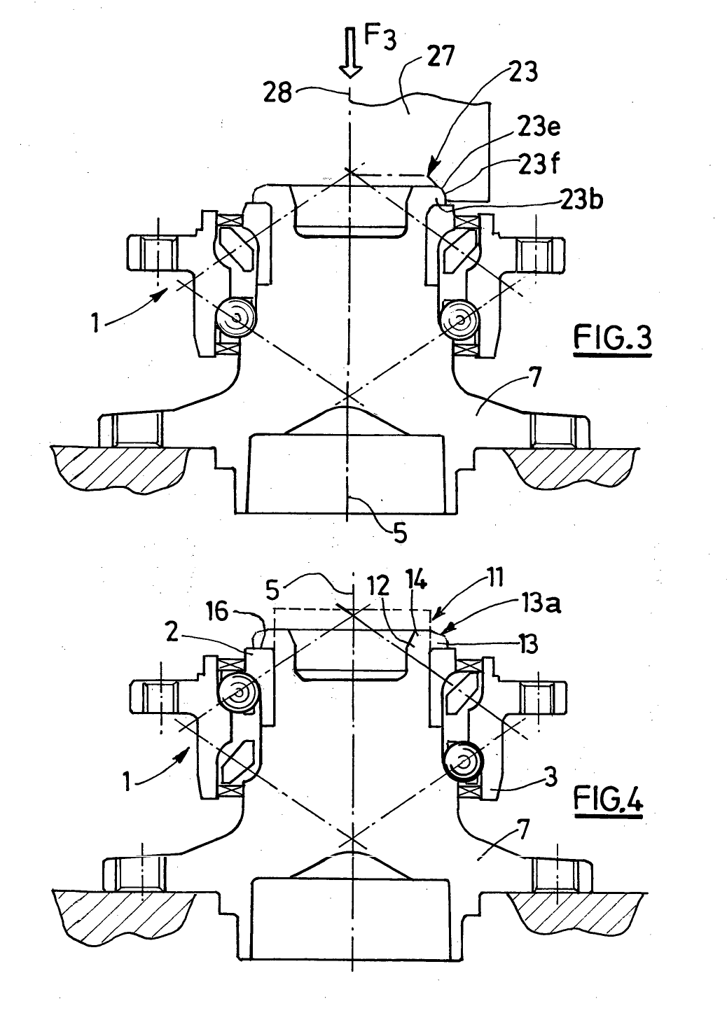

FIG. 3 depicts, in longitudinal section and schematically, the step of spreading the collar preform obtained by implementation of the step depicted in FIG. 2, with a view to forming a holding collar;

FIG. 4 depicts, in longitudinal section and schematically, the assembly of FIG. 1 in which the bearing is held by the collar;

FIG. 5 depicts, in partial longitudinal section and schematically, a first tool for implementing the first deformation step of the method according to the invention;

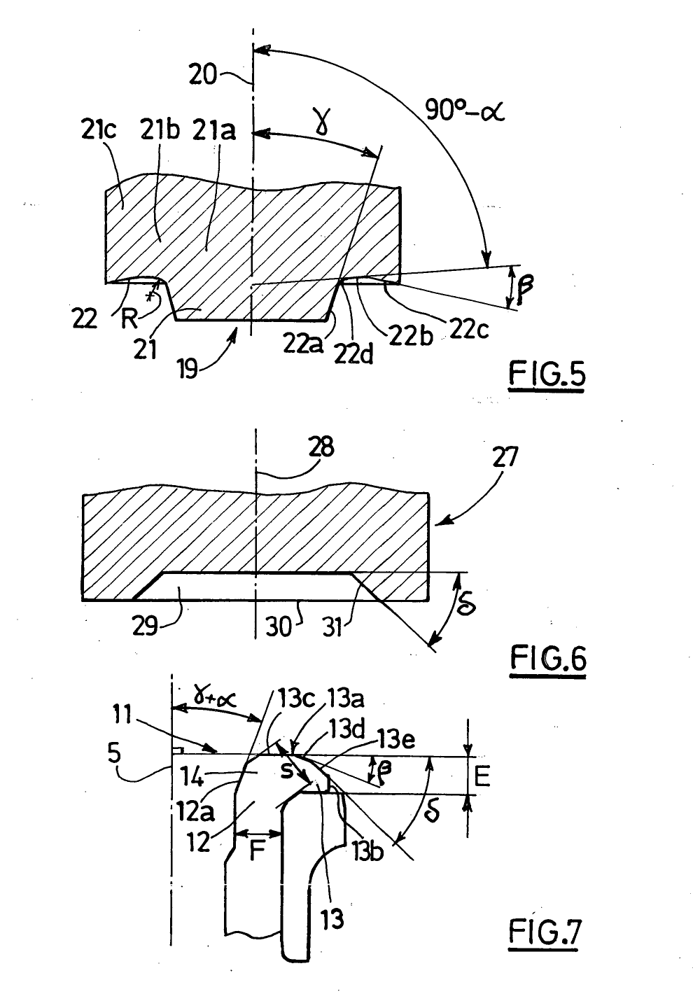

FIG. 6 depicts, in partial longitudinal section and schematically, a second tool for implementing the spreading step of the method according to the invention;

FIG. 7 depicts, in longitudinal section and schematically, a collar geometry obtained by implementation of the method according to the invention with the tools depicted in FIGS. 5 and 6.

FIGS. 1 to 4 depict an assembly comprising a bearing 1 provided with an inner race 2, an outer race 3 and rolling bodies 4 disposed between them in order to allow the relative rotation of these two races 2, 3 about an axis 5.

In the description, the terms “outer” and “inner” are defined with respect to a plane respectively distant from and close to the axis 5, the terms “axial” or “transverse” are defined with respect to a plane parallel to the axis 5 and the terms “radial” or “lateral” are defined with respect to a plane perpendicular to the axis 5.

In the embodiment depicted, the outer race 3 is fixed and the inner race 2 is rotating but, according to requirements, the reverse case can also be envisaged.

The inner race 2 and outer race 3 are formed respectively from an annular ring in which a bore is formed, the bore 6 of the inner race 2 being arranged to allow the disposition of a shaft 7 therein, and that of the outer race 3 to house the inner race 2 and the rolling bodies 4.

In the embodiment depicted, the bearing is provided by two rows of balls 4 kept equidistant by a casing 9. In addition, two facing raceways 8 are produced, one is provided on the respectively outer and inner faces of the inner 2 and outer 3 races and the other directly on the outer surface of the shaft 7 and on the inner face of the outer race 3. In a variant, the inner race can be produced in two parts joined coaxially to each other.

Furthermore, the bearing 1 depicted in FIGS. 1 to 4 is a back axle bearing comprising an outer race 3 provided with a flange 34 for fixing the assembly to a fixed structure, for example the chassis of the vehicle. To that end, the flange 34 comprises fixing holes 35 arranged to allow association by bolting.

These types of bearing are particularly adapted for rotating a wheel hub or axle of a motor vehicle. However, front or back axle bearings, bearings comprising a smooth outer race or other known bearing implementations, in particular those described in the document FR 2 827 202, can be used according to the requirements of the envisaged application.

Moreover, the bearing 1 used can, in a known manner, be provided with sealing means 10 and/or a device for sensing information such as the speed of rotation, the direction of movement and/or the angular position of the rotating race with respect to the fixed race.

The bearing 1 is intended to allow a shaft 7 to be rotated with respect to a fixed structure. In the embodiment depicted, the shaft is a motor vehicle wheel hub 7 and the fixed structure is the chassis of the vehicle.

Although the description is given in connection with a motor vehicle wheel hub, the invention also applies to all assemblies where, in order to rotate a shaft 7 with respect to a fixed structure, it is necessary to hold the bearing 1 on the outer surface of said shaft 7.

In order to allow the hub 7 to be rotated, the bearing 1 is disposed, for example by fitting the hub 7 into the bore 6 of the inner race 2, on the outer surface of the hub 7.

As part of its function, the bearing 1 must be held firmly rotation-wise and translation-wise with respect to the hub 7. To that end, and in view of the forces applied as part of its application, the fitting force is not sufficient to provide sufficient holding.

This is why a radial collar 11 is produced on an end part 15 of the hub 7, said collar 11 coming to abut on at least part of the lateral face 16 of the inner race 2 so as to apply an essentially axial holding force on the bearing 1.

A description is given below, in connection with FIGS. 1 to 4, of the steps of the method of producing such a collar 11 by cold plastic deformation.

The bearing 1 is first disposed coaxially, for example by fitting the hub 7 into the bore 6 of the inner race 2, on the outer surface of the hub 7. To that end, provision is made for the external diameter of the hub 7 and the diameter of the bore 6 to be substantially equal. In a variant, and in order to provide a greater clamping force, the diameter of the bore 6 can be slightly less than the external diameter of the hub 7.

The hub 7 comprises a radial annular surface 17 on which the inner race 2 is abutted in order to allow the bearing 1 to be stopped axially in the fitting direction.

The surface 17 is disposed on the outer face of the hub 7 at a distance such that, once the bearing 1 has been put in contact with the surface 17, part of the hub 7 axially goes beyond the inner race 2.

The hub 7 also comprises an axial bore 18 which, for the part going beyond the inner race 2, forms the hollow annular axial projection 15 on which the collar 11 will be produced.

FIGS. 1 to 4 depict an embodiment in which the hub 7 is that of a non-driving wheel of a motor vehicle. The hub 7 is solid and has a hollow annular housing 18 forming the end part 15 on which the collar 11 will be produced.

According to other embodiments, not depicted, the hub is that of a driving wheel of a motor vehicle. The hub comprises an axial bore which, for the part going beyond the inner race, forms the hollow annular axial projection on which the collar is formed. A driving shaft can be disposed in the bore of the hub in order to be associated by screwing or by any other known means.

In FIGS. 1 to 4, the hub 7 comprises, on the opposite side from the projection 15 or the collar 11, a flange 32 for fixing the assembly to a rotating structure, for example composed of a wheel rim. To that end, the flange 32 comprises fixing holes 33 arranged to allow association by bolting.

The method next comprises two deformation steps which will make it possible to obtain the form of the holding collar: a first deformation and then a spreading.

FIG. 2 depicts the first step of the method during which the projection 15 is deformed radially using a first tool 19 in order to obtain a collar preform 23.

The first tool 19 depicted partially and schematically in FIG. 5 comprises an axis of revolution 20 and a projection 21 formed in two tapered parts 21a and 21b which are superposed along the axis 20, becoming narrower in the direction of the projection 21. A third tapered surface is superposed on the first two, moving away from the axis 20 so as to form with the projection 21 a contact housing 22.

The contact housing 22 thus has three main contact surfaces, namely a transverse surface of revolution 22a inclined by an angle γ with respect to the axis 20, a first lateral surface of revolution 22b inclined by an angle α with respect to the perpendicular to the axis 20 and a second lateral surface of revolution 22c inclined by an angle β-α with respect to the perpendicular to the axis 20. A connecting fillet 22d of radius R is provided between the transverse surface of revolution 22a and the first lateral surface of revolution 22b.

During the first deformation step, the tool 19 is disposed so that its axis 20 forms a non-zero angle α with the axis 5 and then the tool 19 is driven on the one hand with a linear motion along the axis 5 in order to come into local contact with the projection 15 while applying a force F2 and on the other hand with a rotational motion about the axis 5 so as to deform the entire periphery of the projection 15.

In one particular example, the angle α is between 0° and 20°. Moreover, the first tool 19 can be implemented so that the angle γ is greater than or equal to the angle α and the angle β is between 10° and 34°.

In order to allow the deformation, the assembly composed of the bearing 1 and the hub 7 is kept axially in the direction of application of the force F2, for example by a limit stop 24 provided at the opposite side from the projection 15.

According to another implementation, the first tool 19 can remain fixed and the hub 7 can be driven with the two motions mentioned above.

In a variant, the first tool 19 can, moreover, be driven with a rotational motion about its axis 20. To that end, either the tool 19 is left free to turn and the deformation contact causes its rotation, or the rotation is motorised or controlled.

In both cases, the rotation makes it possible to reduce the stresses induced during the deformation by reducing the resultant friction.

This first so-called “orbital riveting” deformation step, by progressively lowering the first tool 19 onto the projection 15, makes it possible to produce an essentially radial collar preform 23. As depicted in FIG. 2, the preform 23 comprises an axial part 23a, a radial part 23b and an intermediate part 23c which connects these two parts 23a, 23b.

In particular, during this deformation step, the transverse surface 22a of the first tool 19 makes it possible to assist the folding of the projection 15 by guiding the material outwards (plastic flow of the material).

Furthermore, the first lateral surface 22b makes it possible to obtain a portion 23d of the free lateral surface of the radial part 23b which is substantially flat and perpendicular to the axis 5.

Also, an intermediate portion 23e of the free surface of the radial part 23b is inclined by the second lateral surface of revolution 22c by an angle β with respect to the perpendicular to the axis 5.

The preform 23 provides, by means of its intermediate part 23c and its radial part 23b, an axial holding force on the bearing 1. However, the end radial part of the collar 11 is not yet formed and the abutment of the preform 23 on the lateral face 16 of the inner race 2 is only partial.

By inclining by a relatively small angle, in particular between 10° and 34°, the intermediate portion 23e of the free surface of the radial part 23b, during the first deformation step, forces are applied a first time moderately on the material which, therefore, is not subjected to too great a stress.

Furthermore, in order in particular to limit the loads applied to the races 2, 3 during the deformation, an axial force F1 can be applied to the inner race 2. For example, the force can be applied by means of a rest 25 put into abutment on the axial face 26 of the inner race 2. In particular, the opening in the rest 25 can comprise an internal bevel which allows the application of a radial force on the inner race, so as to limit its radial expansion during the first step.

The method according to the invention comprises a second deformation step depicted in FIG. 3 during which the preform 23 is deformed using a second tool 27 in order to form the holding collar 11.

The second tool 27 depicted partially and schematically in FIG. 6 comprises an axis of revolution 28 and a contact housing 29 of coaxial tapered general form, widening out towards the opening 30 of the housing 29.

The second tool 27 thus has a contact surface 31, namely a transverse surface of revolution 31 inclined by an angle δ with respect to the perpendicular to the axis 28. The angle δ is strictly greater than the angle β and, in a particular example, the angle δ is between 34° and 60°.

During the spreading step, the tool 27 is driven with a linear motion along the axis 5 in order to come into contact with the preform 23 while applying a force F3 over substantially 360° thereof.

According to another implementation, the second tool 27 can remain fixed and the hub 7 can be driven with the linear motion mentioned above.

This second deformation step, by lowering the second tool 27 onto the preform 23, makes it possible to produce the essentially radial collar 11 by pressing.

The contact surface 31 of the tool 27 deforms an end area of the inclined intermediate portion 23e of the free surface of the radial part 23b so as to form an end area 23f inclined by an angle δ with respect to the perpendicular to the axis 5.

The pressing forces intended for the final forming of the collar are smaller on account of them being applied to an already deformed intermediate portion 23e. Consequently, the material is less stressed than when the second deformation is applied to a surface portion which is flat and perpendicular to the axis 5.

As depicted in FIG. 4, the collar 11 comprises an axial part 12, a radial part 13 and an intermediate part 14 which connects these two parts 12, 13. During the second deformation step, the axial part 23a and the intermediate part 23c of the preform 23 are not substantially deformed and are therefore substantially identical to those of the collar 11. On the other hand, the radial part 23b is subjected to the pressing force so as to be shaped. To that end, the diameter of the opening 30 is substantially equal to the external diameter of the collar 11.

Moreover, the pressing force leads to a folding down of the preform 23 onto the lateral face 16 of the inner race 2, which makes it possible to form a collar 11 providing a large holding function on the hub 7.

In another embodiment, not depicted, during the spreading, the intermediate portion 23e is entirely inclined by the angle δ so that the collar 11 has a radial part 13 whose free annular lateral surface 13a has a portion which is substantially flat and perpendicular to the axis 5 and a portion inclined by an angle δ with respect to the perpendicular to the axis 5.

In a variant, during one and/or the other deformation step, the outer race 3 can be rotated so as to increase the load-carrying capacity of the bearing 1 and therefore reduce the probability of damaging the raceways during these steps.

The implementation of the method according to the invention therefore makes it possible, in two deformation steps, to obtain a collar 11 which provides reliable holding of the bearing 1 on the hub 7.

Moreover, this implementation in two steps makes it possible to first push the material back and then deform it without inducing excessive stresses on the bearing 1.

In addition, by producing an inclined intermediate portion 23e during the first deformation step and next deforming all or part of this intermediate portion in order to obtain the final form of the collar, the collar is formed progressively without imposing too great a stress on the material.

Thus, the intermediate portion, when it remains visible on the collar, implements a progressive connection between the substantially flat portion 23d and the inclined area 23f. Furthermore, when it is fully shaped by the second deformation step, the intermediate portion allows a gradual forming of the collar. In both these cases, the appearance of cracks in the material of the radial part of the collar is avoided.

In connection with FIG. 7, a description is given below of a collar geometry obtained by implementation of the method according to the invention, using the tools 19 and 27 depicted in FIGS. 5 and 6.

As described above in connection with the method, the folding down of the projection 15 is carried out essentially by means of the first tool 19.

In particular, the free annular transverse surface 12a of the axial part 12 is formed by the transverse surface 22a of the first tool 19 so as to be substantially flat and inclined by an angle γ+α with respect to the axis 5.

In a variant, and in particular when the force applied during the second step is large, a rounding of the surface 12a by return movement of material may take place, which leads to the formation of a curved surface.

Moreover, the radial part 13 has a free annular lateral surface 13a and a free transverse end surface 13b substantially parallel to the axis 5.

During the first deformation step, a portion 13c substantially flat and perpendicular to the axis 5 and an intermediate portion 13d inclined by an angle β with respect to the perpendicular to the axis 5 are formed on the free annular lateral surface 13a of the radial part 13 respectively by the first and second lateral surfaces of revolution 22b and 22c of the tool 19.

The implementation of the portion 13c substantially flat and perpendicular to the axis 5 makes it possible to guarantee correct abutment with another component. This implementation is particularly adapted to the case of an engine assembly where a transmission assembly must be put into abutment on this surface 13c.

During the second deformation step, an end area 13e of the inclined intermediate portion 13d is formed by the transverse surface 30 of the tool 27 so as to be inclined by an angle δ with respect to the perpendicular to the axis 5.

Thus, at the end of these two steps, the free annular lateral surface 13a has a portion 13c substantially flat and perpendicular to the axis 5, an intermediate portion 13d inclined by an angle β with respect to the perpendicular to the axis 5 and an end area 13e inclined by an angle δ with respect to the perpendicular to the axis 5.

The second step also makes it possible to improve the holding obtained by means of the collar 11 by providing good contact between the collar 11 and the lateral face 16 of the inner race 2.

The collar 11 can have, as another remarkable characteristic, axial 12, radial 13 and intermediate 14 parts of different thickness respectively F, E and S with E and F less than S, which is recognised as being desirable to obtain good holding.

1. A method of producing an essentially radial annular collar (11) on the hollow annular end part (15) of a component (7), said method comprising the steps making provision to:
radially deform the end part (15) using a first tool (19), the axis (20) of the tool (19) and the axis (5) of the end part (15) forming a non-zero angle α between them, the tool (19) and the end part (15) being driven relatively with respect to each other on the one hand with a rotational motion about the axis (5) of the end part (15) and on the other hand with a linear motion along the axis (5) of the end part (15), so as to obtain a collar preform (23) having a radial part (23b);
spread said preform (23) using a second tool (30), said tool (30) and said preform (23) being driven with respect to each other with a linear motion along the axis (5) of the preform (23) so as to obtain, by pressing, the final forming of the collar (11);
characterised in that, during the deformation, an intermediate portion (23e) of the free lateral surface of the radial part (23b) is inclined by a non-zero angle β with respect to the perpendicular to the axis (5) and in that, during the spreading, at least an end area (23f) of said intermediate portion (23e) is inclined by an angle δ with respect to the perpendicular to the axis (5), the angle δ being strictly greater than the angle β.

2. A method according to claim 1, characterised in that, during the spreading, the intermediate portion (23e) is entirely inclined by the angle δ.

3. A method according to claim 1 or 2, characterised in that the first tool (19) is provided with a contact housing (22) having a transverse surface of revolution (22a) inclined by an angle γ with respect to the axis (20), a first lateral surface of revolution (22b) inclined by an angle α with respect to the perpendicular to the axis (20) and a second lateral surface of revolution (22c) inclined by an angle β-α with respect to the perpendicular to the axis (20).

4. A method according to claim 3, characterised in that the angle γ is greater than or equal to the angle α.

5. A method according to claim 1 or 2, characterised in that the angle α is between 0° and 20°.

6. A method according to claim 1 or 2, characterised in that the angle β is between 10° and 34°.

7. A method according to claim 1 or 2, characterised in that the angle δ is between 34° and 60°.

8. A method according to claim 1, characterised in that the second tool (27) with axis (28) has a contact housing (29) of coaxial tapered general form, widening out towards the opening (30) of the housing (29), said housing (29) having a transverse surface of revolution (31) inclined by an angle δ with respect to the perpendicular to the axis (28) and of which the internal diameter of the opening (29) is substantially equal to the external diameter of the collar (11).

9. A method of holding a bearing (1) on the outer surface of a shaft (7), said bearing (1) comprising at least an inner race (2) provided with an annular bore (6), an outer race (3) and rolling bodies (4) disposed between said races, said shaft (7) having an external diameter substantially equal to the diameter of the bore (6) and at least one hollow annular axial projection (15), said method comprising the steps making provision to:
coaxially dispose the shaft (7) in the bore (6) of the inner race (2) so that at least an end part of the projection (15) is disposed outside the bore (6);
produce on the projection (15), by implementation of the method according to claim 1, a collar (11) extending radially outwards while abutting on at least part of the lateral face (16) of the inner race (2), said collar (11) forming a means of holding the inner race (2) of the bearing (1).

10. A method according to claim 9, characterised in that, during the deformation of the projection (15), an axial force is applied to the inner race (2) so as in particular to limit the loads applied to the races (2, 3) during this step.

11. A method according to claim 9 or 10, characterised in that, during at least one step of producing the collar (11), the outer race (3) is rotated.

12. An assembly comprising a bearing (1) and a shaft (7), said bearing (1) being held or immobilized on said shaft (7) by implementation of the method according to claim 9, said collar (11) comprising an axial part (12), a radial part (13) and an intermediate part (14) which connects these two parts, the radial part (13) having a free annular lateral surface (13a) and a free transverse end surface (13b) substantially parallel to the axis (5), the free annular lateral surface (13a) having a portion (13c) substantially flat and perpendicular to the axis (5), an intermediate portion (13d) inclined by an angle β with respect to the perpendicular to the axis (5) an end area (13e) inclined by an angle δ with respect to the perpendicular to the axis (5).

13. An assembly according to claim 12, characterised in that the shaft (7) comprises, opposite the collar (11), a radial annular surface (17) for immobilising the bearing (1) in the disposition direction.

14. An assembly according to claim 12 or 13, characterised in that the axial part (12) comprises a free annular transverse surface (12a) which is substantially flat and inclined by an angle γ+α with respect to the axis (5) of the bearing (1).

15. An assembly according to claim 12 or 13, characterised in that the axial part (12) comprises a free transverse surface (12a) which is curved.
